(19) United States
(12) Patent Application Publication
(10) Pub. No.: US 2011/0189061 A1
(43) Pub. Date: Aug. 4, 2011

(54) Detergent Delivery Device

(75) Inventors: Dietmar Van Loyen, Ludwigshafen (DE); Emanuele Rossetto, Ludwigshafen (DE); Rainer Link, Ludwigshafen (DE); Axel Halbherr, Ludwigshafen (DE); Francesc Ardite Ayats, Barcelona (ES)

(73) Assignee: Reckitt Benckiser N.V., Hoofdrop (NL)

(21) Appl. No.: 13/058,701

(22) PCT Filed: Aug. 13, 2009
(86) PCT No.: PCT/GB09/01982

§ 371 Date: Apr. 20, 2011

(30) Foreign Application Priority Data
Aug. 16, 2008 (GB) 0815006.2

(51) Int. Cl. B01D 11/02

(52) U.S. Cl. 422/261

(57) ABSTRACT

The invention is an improvement to a multi-dosing detergent delivery device, the device being of a type comprising a housing (2) for receiving therein, in use, a cartridge (200) having a plurality X of chambers (210) each accommodating a detergent composition, a directing means (3,34) to direct, in use, wash liquor selectively into a selected chamber (210) of the cartridge (200) to contact the detergent composition therein, an outlet to allow the detergent loaded wash liquor to exit the device and indexing means (100) for automatic movement of said cartridge (200) in use relative to said directing means (3,34). The specific improvement to the device comprises ensuring that the entry hole (220) of a selected chamber is out of alignment with a hole (34) forming part of the directing means at the start of a heating cycle of a wash, so as to avoid or reduce a problem of detergent held within the chamber (210) from being washed out or diluted during a pre-wash cycle of a dishwasher. In particularly preferred arrangements the gearing of the indexing means of the device is arranged to zero the amount of offset at the end of the heating up cycle.

The invention relates to improvements to a detergent delivery device. In particular, it concerns improvements to multi-dosing detergent delivery devices of the type used, for instance, within dishwashing machines where a detergent is dispensed automatically over a plurality of washing cycles without the requirement for a user to refill the device.

A number of devices are known for holding unit doses of a detergent composition or additive, such as detergent tablets, and for dispensing of such unit doses into a machine.

WO 01/07703 discloses a device for the metered release of a detergent composition or additive into a dishwashing machine having a number of separate sealed chambers for holding the detergent composition or additive and means for piercing the chambers, activated by conditions within the machine.

WO 03/073906 discloses a free standing device for dispensing multiple doses of detergent into a dishwasher. The device has a plate-like construction. A round blister pack having a plurality of doses arranged around its periphery is loaded into the pack. A winder is then rotated to load mechanical energy into the device sufficient to dispense more than one dose of detergent. A thermally operated latch then moves when the device is subjected to the elevated temperatures within the dishwasher and, in cooperation with a ratchet mechanism, moves the blister pack so that the next dose of detergent is ready for dispensing. In order to dispense the detergent, either the blister pack is pierced, or the dose is ejected from its compartment within the blister pack.

WO 03/073907 discloses a similarly shaped free standing dispensing device. In order to dispense detergent, a lever is manually operated to move a blister pack either to eject the detergent from a compartment within the blister pack, or to pierce the blister pack. A door or flap initially prevents wash liquor within the machine from accessing the exposed detergent. A bi-metallic strip is provided to move the door or flap when the device is exposed to the elevated temperatures during a washing cycle to allow access of the wash liquor to the exposed detergent thereby dispensing the detergent to the machine.

One particular device of great utility, which is the subject of PCT application WO/2008/053178 comprises a multi-dosing detergent delivery device, the device comprising a housing for receiving therein a cartridge having a plurality X of chambers each accommodating a detergent composition, a directing means to direct, in use, wash liquor selectively into a chamber of the cartridge to contact the detergent composition therein and an outlet to allow the detergent loaded wash liquor to exit the device, wherein the device further comprises indexing means for automatic movement of said cartridge, in use, relative to said directing means during and subsequent to a wash cycle so as to cause a neighbouring chamber to be in an exposed, ready to be used, position prior to a next washing cycle.

The above-mentioned device has a particularly refined automatic indexing mechanism for automatically advancing between doses of detergent and is particularly advantageous in that it can cope with the fact that a dishwasher machine may during a single cycle include intermediate cycles where temperatures may rise in an initial part of a cycle, then drop and subsequently rise again. In such situations other devices may “double dose” the detergent, whereas the device of WO/2008/053178 avoids this by the use of a thermally reactive element such as a wax motor which expands a wax canister during a heating phase of a washing cycle and contracts as it cools during and subsequent to a final cooling phase of said washing cycle. Here, the relatively slow reaction of the wax canister and the fact that a majority of movement of the indexing mechanism happens during a cooling cycle manages the situation of avoiding double dosing

To understand the operation of this prior art device in a little more detail, that device will now be described with reference to the accompanying drawings, in which:

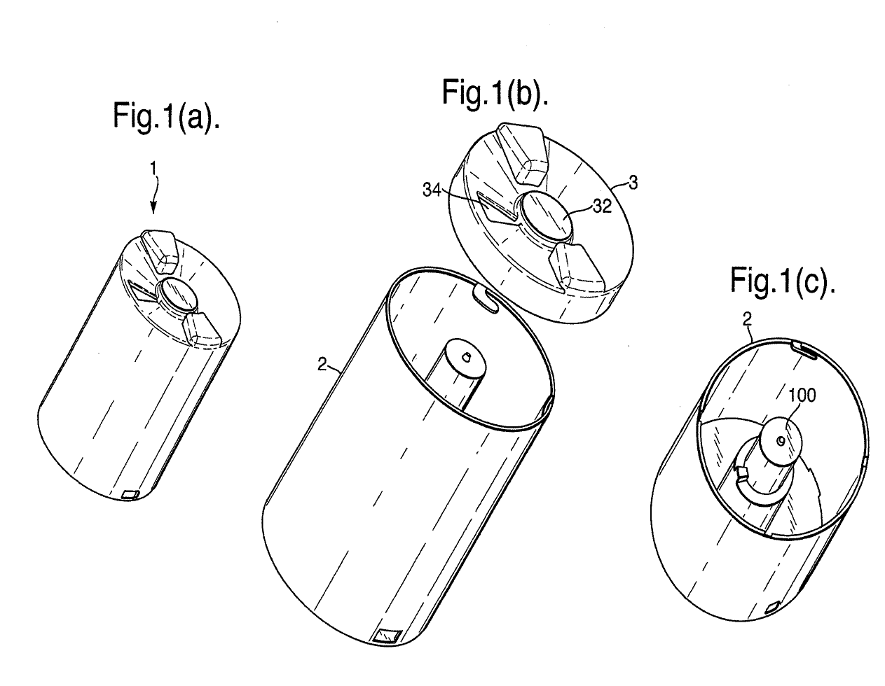

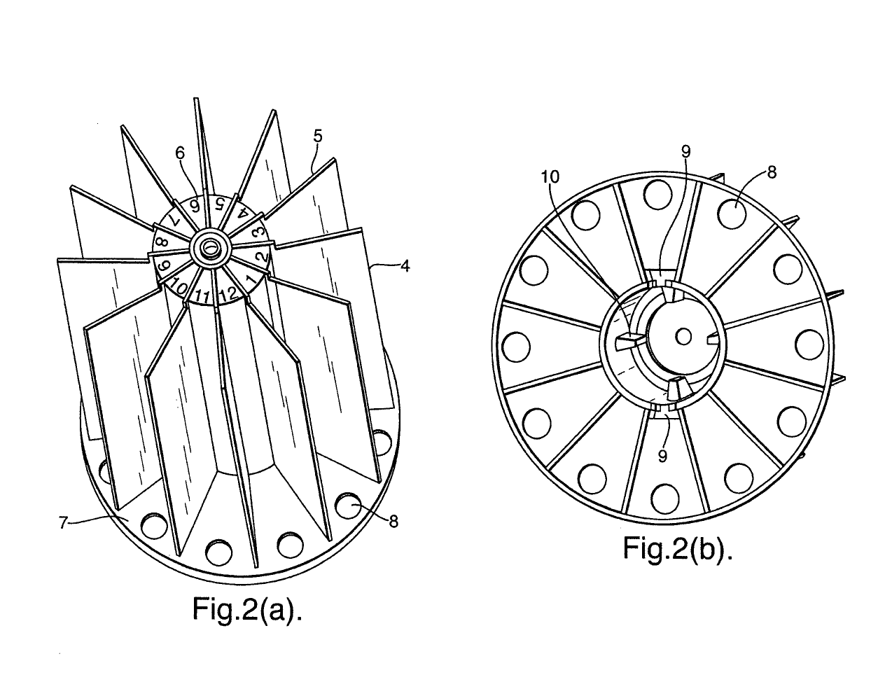

FIGS. 1(a), 1(b) and 1(c) are perspective assembled, perspective exploded and internal perspective views of a housing part and lid of the device of WO/2008/053178;

FIGS. 2(a) and (b) are schematic perspective views from above and from below showing a refill holder for use with the device of WO/2008/053178;

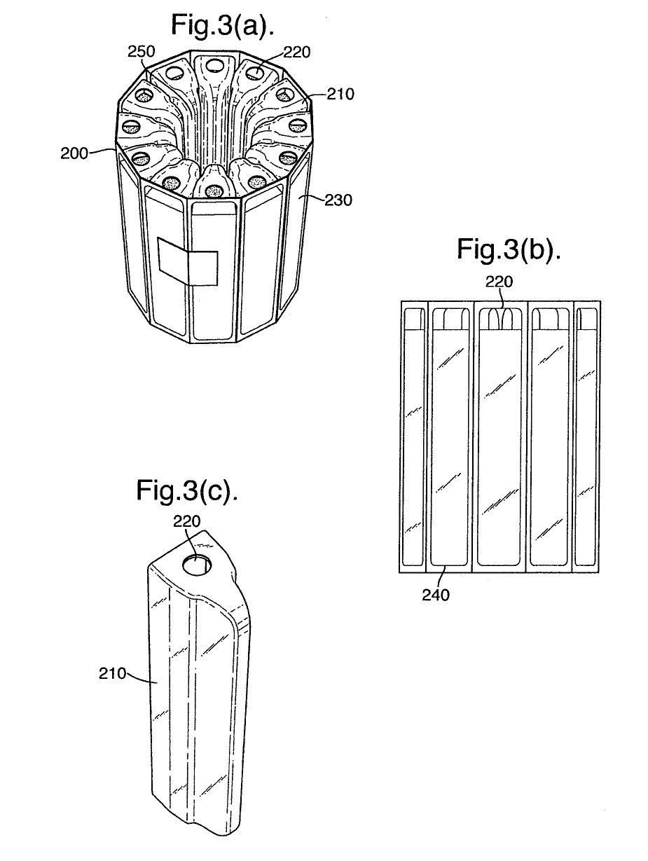

FIGS. 3(a) and 3(b) show a refill cartridge for use with the refill holder of FIGS. 2(a) and (b), whilst FIG. 3(c) shows a single chamber of a refill cartridge;

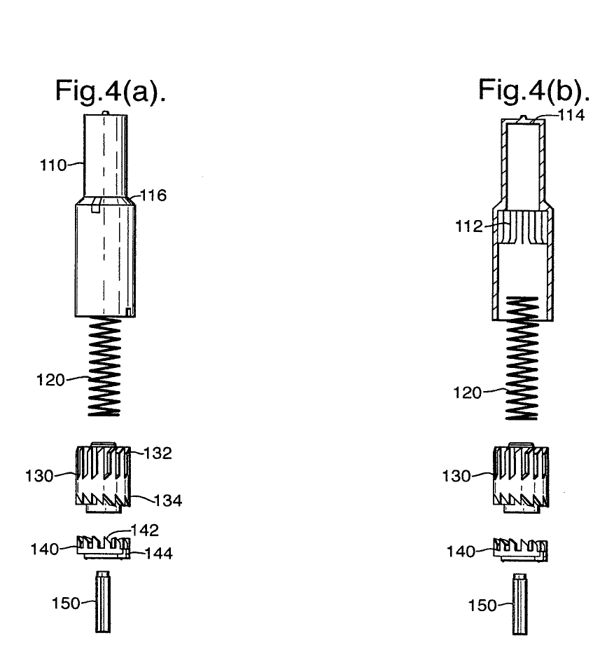

FIGS. 4(a) and 4(b) are perspective exploded and perspective partial assembly views of an automatic indexing mechanism of the device of WO/2008/053178;

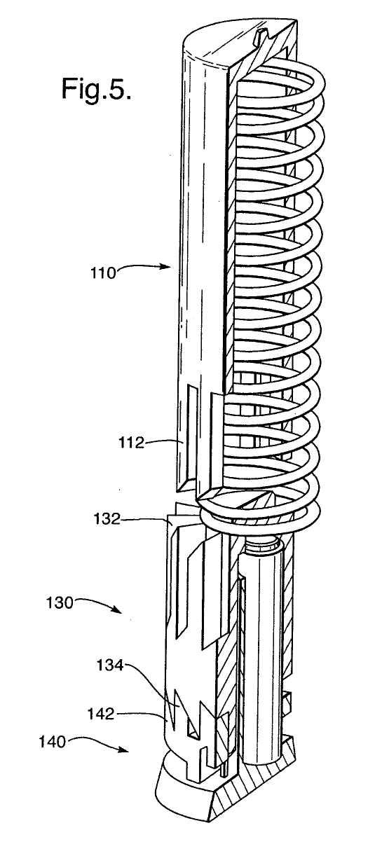

FIG. 5 shows in perspective cross-sectional view the automatic indexing mechanism of FIG. 4;

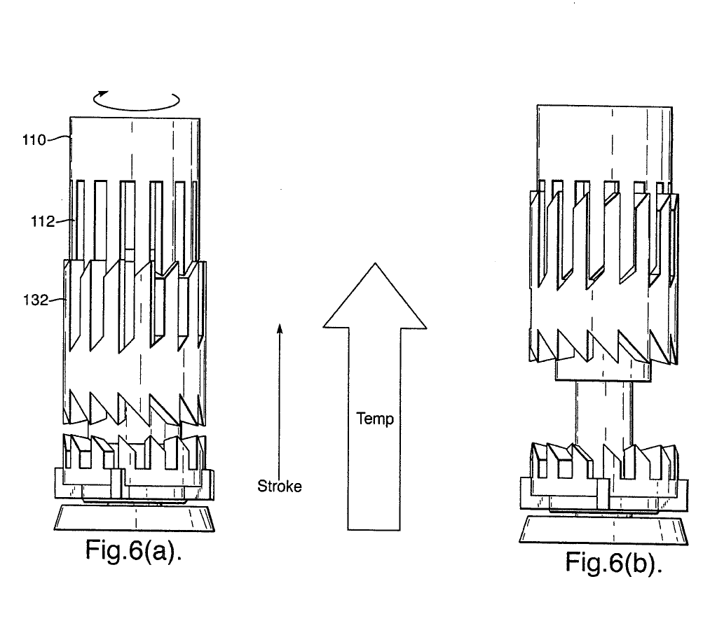

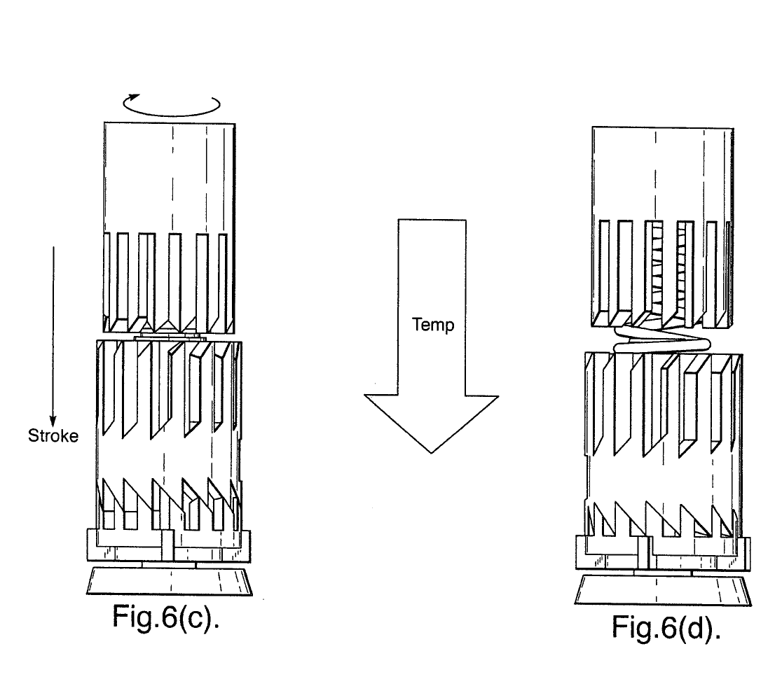

FIGS. 6(a) to 6(d) show the various states of the indexing mechanism of FIGS. 4 and 5 as temperature within an appliance utilising the device changes during a dishwashing cycle;

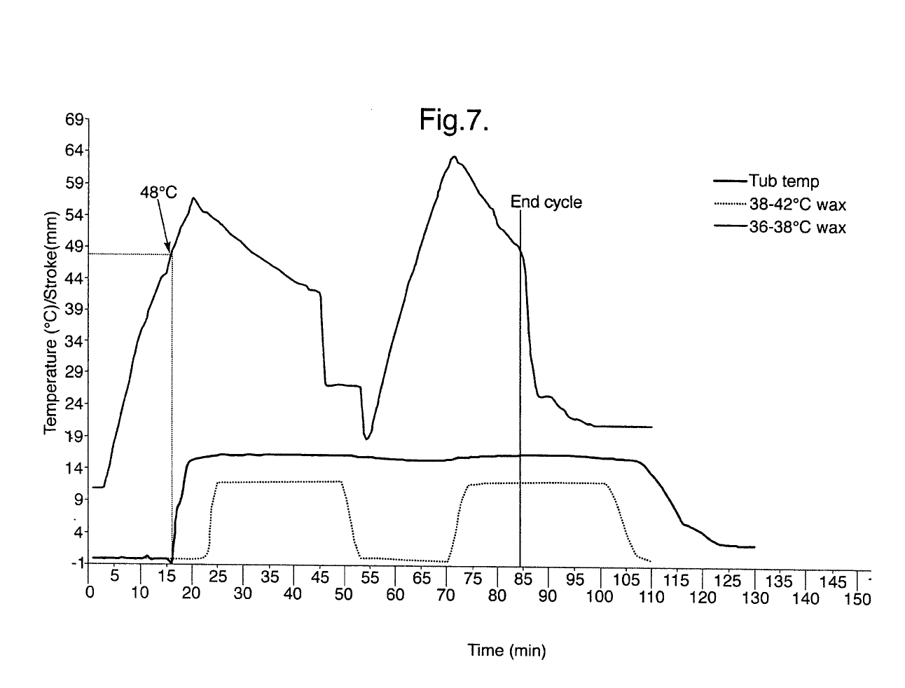

FIG. 7 shows a graph of temperature fluctuations over time during a typical dishwashing cycle and of the variations in activation state of a wax motor canister during the same period of time.

FIGS. 1(a), 1(b) and 1(c) show respectively perspective assembled, perspective exploded and internal perspective views of detergent dispensing device 1 comprising a housing 2 and a lid 3. The housing 2 has an indexing mechanism 100 housed within it and described later. The lid 3 has a window 32 to allow a user to see by means of a visual indicator a number of washes used or remaining for use with the device and also has directing means comprising an aperture 34 for directing wash liquor/water to the interior of the housing. The lid 3 has a general funnel like appearance to facilitate the collection of wash liquor/water available to the directing means.

The housing 2 is arranged to receive a refill holder 4 as shown in FIG. 2(a) which shows a refill holder in front perspective view and FIG. 2(b) which shows the holder in bottom perspective view. The refill holder 4 comprises a plurality of dividing fingers 5 emanating from a central hub 6 and has a base 7 featuring a number of apertures 8 and lower location slots 9. Internally of the hub 6, there are formed one or more upper locating tabs 10 (four shown in the figure), whilst externally and at a central portion thereof there is provided numbering from 1 to 12 representing the number of washing cycles that an associated refill may have undergone or have remaining. The window 32 of the lid has a transparent portion that is, in use, aligned with the relevant sector of the numbered area.

The refill holder 4 is, in use, positionable within the housing 2 and the hub 6 has a hollow formation to co-operate with, and fit over, a central shaft 120 of the indexing mechanism 100 as will be described later.

The fingers 5 are arranged to co-operate with and register with internal spaces formed between parts of a disposable refill package 200 such as the one shown in FIGS. 3(a) and 3(b) and having individual chambers 210 as shown in FIG. 3(c). The refill package 200 is a cartridge that comprises a plurality of like chambers 210, and has a roll formation. The chambers 210 are separate from each other and comprise plastic sleeve or blister packages. The chambers 210 are spaced apart, having gaps between them that are apt to be engaged by the fingers 5 of the refill holder 4. Each chamber has an upper opening 220 and a lower opening 240 that is, in use, in register with one of the apertures 8 of the refill holder. Each chamber 210 is filled with sufficient cleaning composition for the completion of one dishwasher cycle. The contents of the chambers 210 are preferably in solid form and, therefore there is no problem with inadvertent spillage. There is also a central gap 250 in a central hub area that facilitates the placement of the refill 200 onto the refill holder 4.

Referring now to FIGS. 4(a) and 4(b) there is shown an indexing mechanism for automatically rotating the refill holder 100 and refill 200 of the device 1 relative to the housing 2 and lid 3.

The indexing mechanism 100 comprises a shaft 110, a spring 120, a cursor element 130, a cam 140 and a thermally reactive element that is preferably a wax motor 150.

The shaft 110 is hollow and receives the other components of spring, 120, cursor 130, cam 140 and wax motor 150 therein.

The shaft 110 has a closed end region 114 for providing a seat to the spring 120 and, approximately mid-way down a length of the shaft 110 there are formed internally a plurality of spaced apart downwardly depending straight parallel grooves 112, each of these grooves has a sloping lowermost portion as will be described presently.

The cursor 130 is locatable within the shaft 110 and, at its upper most portion provides a lower seating for the spring 120. It also has moulded thereon an upper and lower set of gear teeth 132, 134.

Cam element 140 is arranged for selective co-operation with the cursor element 130 and it too has an upper set of gear teeth 142 and has locating tangs 144 to locate it positively in use against refill holder 4. The cam element 140 has a central aperture to allow the wax motor element to sit within it.

Wax motor 150 comprises a wax can and a piston. Essentially, as wax is heated it expands and pushes against the piston, as it cools down, the wax contracts and, aided by spring action of the spring 120, the piston returns to its original position. In the device of the preferred embodiment, the wax motor sits at the bottom of the shaft 110 in the space provided by the central aperture of the cam element and the piston acts so as to cause the cursor 130 to rise and fall as appropriate during a heating/cooling cycle.

The inter-relation between all of the parts mentioned up to now will next be discussed.

Firstly, it will be appreciated that the housing 2, indexing mechanism 100 and the refill holder 4 are readily assembled into a single unit. Referring to FIG. 5, there is shown in a partial cut-away form a part of the shaft 110, the spring 120, cursor 130 and cam 140 all seated within the shaft 110. Here, the spring 120 seats against the internally closed top end of the shaft 110 and against the top of the cursor 130, whilst the wax motor 150 is positioned within the central aperture of the cam 140 and, at its lower end bears against a part of the base of the housing 2 and at its upper end against the cursor 130. The refill holder 4 is placed over the shaft 110 of the indexing mechanism and is located thereon by co-operation of its locating tabs 10 with corresponding formations in the form of locating slots 116. The refill holder also locates to the cam element 140 by co-operation between slots 9 and tangs 144, so that the shaft 110 and the cam 140 are locked to the refill holder 4.

Although not shown in the figures, the cursor element 130 is constrained such that it cannot rotate with respect to the holder 2, but it can be displaced in the vertical plane as such, it constitutes a linear element. The refill holder 4 on the other hand, is (once a refill 200 has been associated with it and the device 1 has been closed by associating the lid 3 with the housing 2) constrained such that it cannot be significantly displaced in a vertical direction, but is capable of rotation within the housing 2 and as such constitutes a first rotational element.

There will now be described, with reference to the figures the use of the device and a cycle which takes place upon heating of an assembled device/refill combination.

When the user first receives the device, the user will note that the lid of the device 3 includes a window 32, through which one of the numerals on the number dial 6 is visible. For a new device, the preferred number that the user will see is number “1”. This indicates to the user that the device is a new device, and is ready for its first cycle within the dishwashing machine.

Generally, the device will include a clip or mounting device (not shown), which will permit the user to attach the device to a wire basket of a dishwasher, preferably in a discrete location such as a corner. The user then need only close the door of the dishwasher and select an appropriate programme.

The device as shown in the figures hosts twelve separated doses of detergent, within twelve individual chambers.

In the start position for the very first wash, an aperture 34 in the lid 3 is generally aligned with opening 220 of the refill 200. It should be noted here that lower opening 240 (which in general is of an identical size to upper opening 220) is an outlet hole, whilst upper opening 220 is an inlet hole, so that water dispensed by a dishwasher during a washing cycle and collected by the lid 3, may wash through the exposed compartment 210, and enter into the dishwasher carrying dissolved or particulate cleaning composition from the chamber 210. The lower opening 240 need not be precisely aligned with a particular outlet hole formed in the housing 2, but instead the housing 2 may simply have one or more drainage holes which, under gravity, will allow the water and cleaning composition to exit from the device 1.

Indexing of the refill holder 4, and its associated refill package 200 so that a next chamber 210 is ready during a second washing cycle is accomplished by means of the indexing mechanism 100.

The general principles promoting the indexing of the refill 200 and holder 4, are that the indexing mechanism 100 includes a wax motor element 150. This wax motor element 150, basically consists of a wax can and piston. In preferred embodiments, the wax motor delivers up to 300 N of force. When the water in the dishwasher gets warm, the wax in the can starts to expand and pushes the piston out of the wax can. When the dishwasher cools down, strong spring 120 pushes the piston back into the wax can.

Up and down movement of the piston of the wax motor 150 is translated into a rotation of the refill cartridge 200 and its holder 4, by means of a gearing system comprising the cam, cursor, and shaft of FIGS. 4(a) and (b).

FIG. 5 shows schematically a start position of the gearing system, in which the linear element, the cursor 130, is meshed with a first rotational element in the form of cam element 140, but separated from contacting with the interior of the shaft 110 (which forms a second rotational element). In other words, the upper set of gear teeth 132 of the cursor 130 are completely separated from the parallel grooves 112 forming gear teeth of the shaft 110, but the lower set of gear teeth 134 of the cursor 130, are meshed with the gear teeth 142 of the cam 140.

Here, it should be noted that each of the portions acting as gears, include sloping teeth, for promoting gear meshing in a particular rotational direction, and gap portions for ensuring positive engagement in particular positions.

In the state shown in FIG. 5, there is no heat applied to the wax motor 150. However, within the dishwasher cycle, the conditions applied involve rising temperature sections, during a given washing programme, followed by cooling conditions. The functioning of the mechanism comprising the wax motor 150, and the various cam 140, cursor 130, and shaft 110 motions will now be described in particular with reference to FIG. 6(a) through FIG. 6(d).

FIG. 6(a) shows what happens during a first part of a heating cycle. During this heating cycle, the piston of the wax motor 150 extends so as to raise the cursor element 130, and disengage the lower gear teeth 134 of the cursor 130, from the gear teeth 142 of the cam 140. Indeed, as the cursor element 130 rises, the lowermost extent of the cursor 130 becomes completely clear of the cam element 140. At some point, during the heating cycle, sloping surfaces of the upper set of gear teeth 132 of the cursor 130, come into contact with sloping surfaces at the end of gear teeth provided by the formations 112 internally of the shaft 110. It is to be noted here that the sloping surfaces co-operate in such a manner that, as the cursor 130 may only move in the vertical plane, but the shaft 110 cannot move in the vertical plane, but instead is allowed to move rotationally in the horizontal plane, the shaft 110 is forced to rotate in the direction dictated by the sloping surfaces. In this way, as temperature rises still further, the point shown in FIG. 6(b) is reached, where a partial rotation of the shaft 110, and thereby of the associated refill holder 4, and refill 200 has occurred and, further heating simply results in the cursor 130 rising still further, and its upper gear teeth 132, which are elongated, rise vertically into gaps formed between the gear teeth 112. Therefore, during a heating cycle, a controlled amount of rotation occurs, dictated by the formation of the gearing of the upper teeth 132, and the formations 112 (which for reasons which we shall explain later gives a 6° rotation during a heating cycle) is facilitated and, thereafter, further heating does not cause further rotation, but instead causes greater meshing between the gear teeth 132, and the gaps between formations 112 on the shaft.

Thereafter, during a prolonged cooling cycle, the procedures shown in FIGS. 6(c) and 6(d) occur. Firstly, during the cooling, the cursor 132 descends vertically, as the piston of the wax motor 150, retracts under action of the spring 120. Eventually, the cursor pulls clear of the formations 112 of the shaft 110. Then, during a final phase of the cooling cycle, the lower set of teeth 134 of the cursor 130, come into contact with the gear teeth 142 of the cam 140. Here, it will be noted that both the cam 140 and the shaft 110 are linked to motion of the refill holder 4, and refill 200, and therefore the cam 140 also underwent the 6° rotation undergone during the heating cycle. Consequently, when the lower set of gear teeth 134 descend to meet the gear teeth 142 of the cam 140, they are not aligned, as they previously were. As the sloping surfaces formed on the top of the gear teeth 142, and on the base of the lower set of gear teeth 134, come into contact with each other a rotational movement of the shaft 110, refill holder 4 and refill 200 is caused. Here, the gearing of the sloping surfaces of the meshing teeth, are arranged so as to bring about a 24° rotation (again for reasons which will be described later). So that in the eventual position shown in FIG. 6(d) the lower set of gear teeth 134, are fully meshed with the gear teeth 142 of the cam 140. Again, it is of course noted that the cursor 130 is constrained to movement within the vertical plane, whilst the cam 140 and shaft 110, which are interlinked by the refill holder 4, are constrained to movement rotationally, within the horizontal plane.

From the above description, it can be seen that during any given washing cycle, heating up of the wax canister forming the wax motor 150, causes extension of a piston of the wax motor 150, and brings about vertical motion of the cursor 130. This vertical motion is translated into horizontal rotational movement of the shaft by a first amount during the heating cycle, and then by a second amount, at the end of a cooling cycle. By selection of an appropriate wax within the canister, and by ensuring that gaps between gear teeth (and in particular the upper set of gears provided between the cursor 130 and the formations 112 of the shaft 110), are sufficiently elongated so that any cooling during intermediate washing cycles, does not promote sufficient retraction of the piston of the wax motor 150 under spring action 120 to cause any early meshing of the lower set of gear teeth 134, and the gear teeth 142 of the cam 140. Thereby, only at the end of a washing cycle, do these latter set of teeth mesh, and promote the further rotational movement.

The above process is illustrated schematically in FIG. 7, which shows a possible scenario of a washing cycle.

In the graph of FIG. 7, the upper line represents temperature variation over time, the intermediate solid line illustrates the expansion and contraction of a preferred wax composition over time, whilst the lower line (shown hatched) illustrates the expansion and contraction of a different wax composition. The preferred wax composition will be referred to as 36-38° C. wax, whilst the non-preferred composition will be referred to as the 38-42° C. wax.

It will be appreciated that insulation of the wax motor 150, means that tub temperatures are not immediately presented to a given wax motor, as they are not felt immediately by the wax within the wax motor. Thereby, looking at the preferred wax composition, it can be noted that once a tub temperature of 48° C. has been reached during a given washing cycle, the piston of the wax motor, may be started to be urged upwardly by the expanding wax, until, it reaches a fully expanded position. The degree of insulation provided to the wax within the wax motor 150, and the use of a so-called “lazy” composition, means that even though the temperature within the tub falls during an intermediate cool cycle to be below a nominal 36° C. temperature level, this does not translate during the short period for which it occurs (shown on the timeline as being between 45 and 60 minutes after the start of a long cycle), into sufficient retraction of the piston of the wax motor 150, to cause any problems. Indeed, because of the “lazy” properties of the wax, there is quite a time lag between the end of a cycle occurring at the 80 minute mark, and the final movement (contraction) of the wax motor 150, which does not occur until approximately the 100 minute mark. Thereby, a double actuation is avoided. Looking however at the inferior wax composition shown by the bottom line, it can be seen that use of such an inferior composition, can mean that once an activation temperature of the wax is reached, a quick reaction of the wax, during a cooling cycle, can cause piston retraction, and then, following the final heating of the tub temperature, a further activation of the wax piston can occur—leading to the “double actuation” problem.

By ensuring that movement of the chamber during the wash translates only to an additional 6°, the device can start with a fully exposed detergent chamber in which the totality of the opening 220 is within the area of the aperture 34 of the lid 3. Then during a cooling cycle, a further movement of 24° during such cooling brings the next chamber into full exposure for the following wash.

Here, it will be noted that total movement of the device during a heating and cooling cycle is 30°, which of course is 1/12 of 360° and, therefore, the preferred arrangement is to have twelve chambers, with twelve doses of cleaning composition. During the 6° movement of the refill and holder during a wash, the initially fully exposed detergent chamber becomes partially closed, but still open to the flow of water. However this movement does not lead to exposure of the neighbouring chambers because there is a gap between the chambers 210 to protect neighbouring chambers from water spray ingress and therefore avoiding the problem of pre-dissolution of the detergent in the chamber for the following wash. Therefore, a dishwashing cycle begins with a fully exposed chamber right from the beginning.

The above has described, in some detail the operation of an automatic dishwasher with 6 degree and 24 degree advancement of refill cartridge during warm-up/cool down cycles.

The majority of automatic dishwashing machines include pre-wash cycles as well as main cycles during any given overall cleaning cycle as chosen by the consumer. The pre-wash, if chosen, may be short (e.g. 5 minutes) or long (e.g. 20 minutes). In European dishwashers the water temperature is generally cold for pre-washing, whilst in the United States it is generally hot (about 49 degrees C.).

In the aforementioned and described device, the detergent is open 100% to the flow of water right from the start of the pre-wash leading to a partial dissolution of the detergent during the pre-wash cycle. Usually, the automatic indexation of the device does not activate until the temperature rises during the main wash, with final movement of the mechanism during cooling.

Whilst the use of automatic dosing devices is a major additional convenience to the user, the concentration of detergent being available during the main wash part of a cycle can be rather reduced as a result of the partial dissolution during pre-wash. This in turn leads to an overall reduced cleaning performance compared with the cleaning potential of a detergent that is dosed 100% during a main wash cycle. The “loss” of detergent in the pre-wash depends upon the length of the pre-wash and the temperature of the water as well as the wash liquor/water flow within the dishwasher. This last factor is also dependent on placement of the device within the dishwasher itself, the loading of the dishwasher and the pumping technologies applied in the dishwasher—these parameters however are generally not something considered to be within the realm of influence (or interest) of the consumer.

It is an aim of preferred embodiments of the invention to provide a means for preventing or obstructing water flow into an open chamber of the device during a pre-wash cycle.

According to a first aspect of the invention, there is provided a multi-dosing detergent delivery device, the device comprising a housing for receiving therein, in use, a cartridge having a plurality X of chambers each accommodating a detergent composition, a directing means to direct, in use, wash liquor selectively into a selected chamber of the cartridge to contact the detergent composition therein, an outlet to allow the detergent loaded wash liquor to exit the device and indexing means for automatic movement of said cartridge, in use, relative to said directing means, the device further comprising means for blocking or obstructing passage of water/wash liquor from said directing means to the selected chamber during part of a wash cycle.

Preferably, said means for blocking or obstructing passage of water/wash liquor comprises providing an offset between an entry hole of a selected chamber of the cartridge and a hole of the directing means, so that the hole of the directing means and the chamber entry hole are not in full alignment prior to the commencement of wash cycles.

Preferably, the offset is arranged so as to provide an exposure percentage “M” of the chamber entry hole prior to the commencement of wash cycles, where “M” is less than 100%. Most preferentially “M” is within the range of 0 to 80%.

Preferentially, gearing of said indexing means is arranged to apply an indexation so as to proceed to a 100% exposure of the chamber entry hole during said heating cycle.

Preferentially, said device is cylindrical and said X chambers each occupy (360/X) degrees of said cylinder and the offset between the hole of the directing means and the chamber entry hole is “−Y” degrees, where Y is between 4 and 15.

Most preferably, said chamber entry hole is larger than said hole of said directing means, such that indexation of said device during a heating cycle will bring about a 100% exposure level before alignment of centre points of said respective holes along common central axes occurs.

Examples of embodiments of the present invention will now be described with the aid of the accompanying drawings, in which:

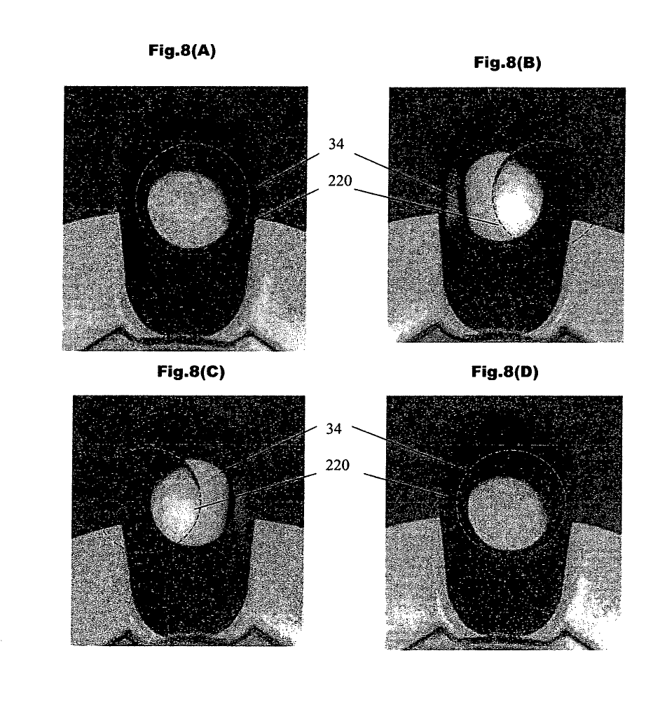

FIGS. 8(A) to 8(D) show an arrangement of cartridge in which in FIGS. 8(A) and 8(B) there is shown respectively an entry hole position to a selected cartridge chamber in accordance with the prior art in a begin wash cycle state and a state in which an indexing of the cartridge of 6 degrees has occurred during a heating cycle, whilst in FIGS. 8(C) and 8(D) there are shown equivalent views in which a cartridge has its entry hole offset by −6 degrees so as to be partially obscured during a beginning phase of a wash cycle;

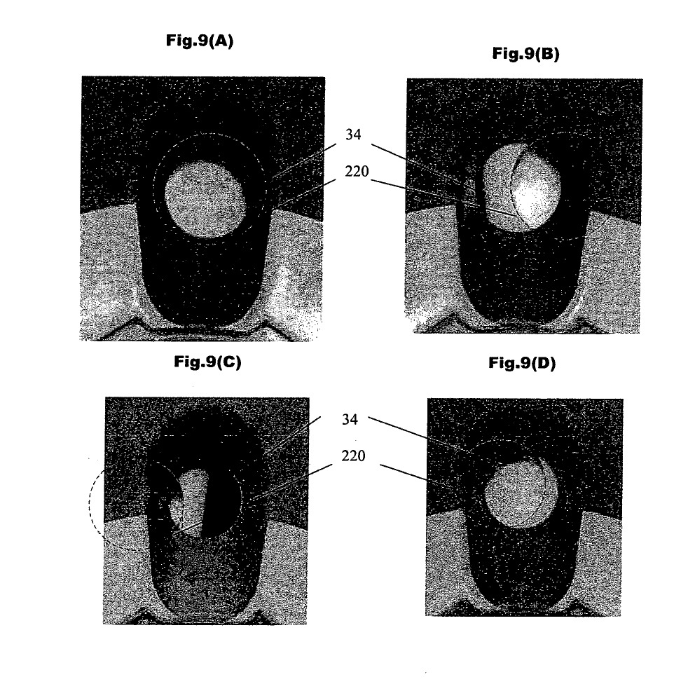

FIGS. 9(A) to 9(D) show an arrangement of cartridge in which in FIGS. 9(A) and 9(B) there is shown the same views as in FIGS. 8(A) and 8(B), whilst in FIGS. 9(C) and 9(D) there are shown equivalent views in which a cartridge has its entry hole offset by −12 degrees, so as to be obscured to a greater degree than the entry hole of the cartridge of FIG. 8(C), during a beginning phase of a wash cycle;

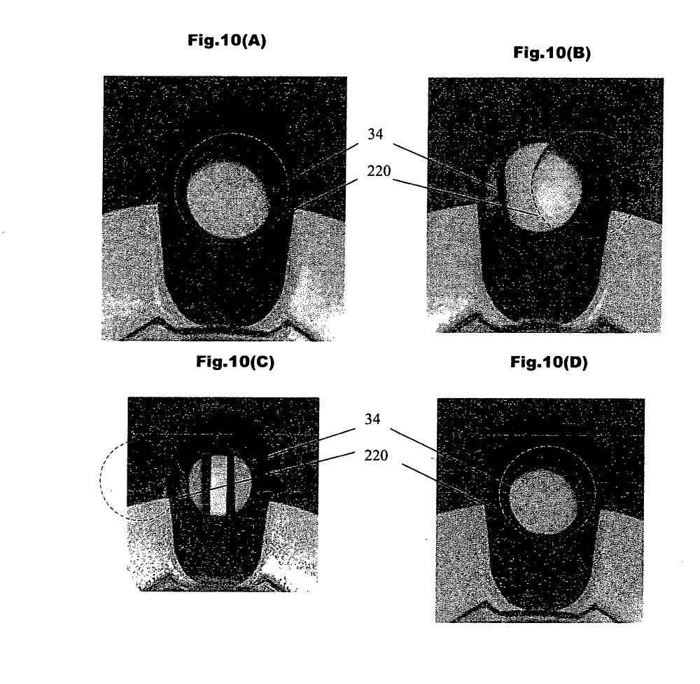

FIGS. 10(A) to 10(D) show an arrangement of cartridge in which in FIGS. 10(A) and 10(B) there is shown the same views as in FIGS. 8(A) and 8(B), whilst in FIGS. 10(C) and 10(D) there are shown equivalent views in which a cartridge has its entry hole offset by −15 degrees so as to be substantially totally obscured during a beginning phase of a wash cycle; and

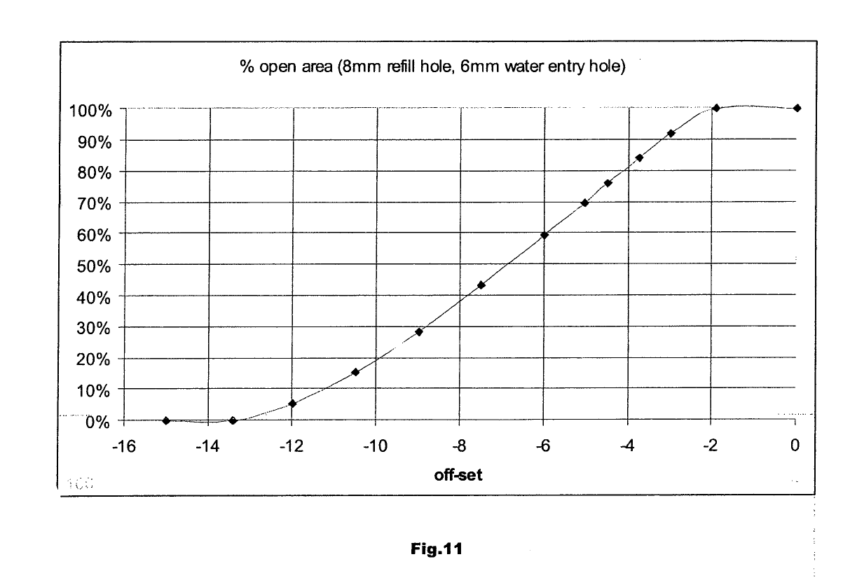

FIG. 11 is a table graphing the exposed percentage area of an entry hole of a selected cartridge at the start of a wash cycle versus the degree of offset applied to the cartridge/cartridge hole at the beginning of a wash cycle.

With a view to mitigating the problems of detergent loss during pre-wash, an improvement is proposed where an off-set of an opening 220 of the selected refill chamber 210 and the position of the water entry hole 34 of the device lid 3 is introduced.

The offset leads to a reduced open area and therefore a reduced water flow at the start of washing cycles when compared to the arrangements as described in relation to FIGS. 1 to 7 above.

In the prior device, twelve detergent chambers are present in a circular orientation and the movement between of the indexing mechanism to go between each chamber is therefore, 30 degrees. With a typical hole 220 at the top of each refill chamber being of 8 mm diameter and a water entry hole size 34 in the lid 3 being of 6 mm, applying an offset to the positioning of the cartridge with respect to the hole 34 in the lid of the device will vary the degree of exposure of the selected cartridge chamber hole 220 (i.e. will vary the respective alignment of hole 220 with hole 34).

To illustrate this offsetting, we now refer to FIG. 8(A) through (D).

In FIG. 8(A) there is shown the prior art device as discussed in relation to FIGS. 1 to 7 and showing the complete alignment of water entry hole 34 in the lid 3 with the chamber hole 220 (represented by a broken line) whereby the centre points of the respective holes 34 and 220 lie on common central axes for a selected chamber at the beginning of a wash cycle.

FIG. 8(B) shows the same device after movement of the indexing mechanism by 6 degrees has occurred during the heating phase of a washing cycle. Here, it can be seen that the two holes move from complete alignment into partial alignment, with the selected chamber 210 being exposed to water ingress throughout the heating cycle of the dishwasher.

FIG. 8(C) shows a first embodiment of the invention in which an offset to the cartridge and the lid is applied so as to have a −6 degree offset giving a reduced amount of exposure to the contents of the cartridge at the start of a heating cycle, with the 6 degrees of indexation then bringing about a state in FIG. 8(D) in which the holes and 220 are completely aligned at the end of the heating cycle. Put another way, and referring to the graph of FIG. 11, a −6 degree offset gives an approximate 60% open area of the cartridge hole at the beginning of the wash cycle, i.e. if the situation shown in FIG. 8(A) where refill hole and water entry hole are aligned is considered to be 100%, then the offset of −6 degrees is 60% on the FIG. 11 graph. This goes some way to limiting exposure of the chamber 210 to entry of water during a pre-wash phase and helps mitigate the problem of detergent “loss”.

Referring now to the graph of FIG. 11, it can be seen that due to the difference in sizes of the water entry hole and the refill chamber hole (6 mm and 8 mm diameter respectively), a −6 degree offset between complete alignment of the two holes at the beginning of a wash cycle will, by the time the mechanism has indexed only 4 degrees turn into a full exposure of the contents of the chamber. Or put another way, when regarding the smaller water entry hole after 4 degrees of indexation, the open area of the refill chamber hole is already fully exposed so that full “exposure” of the refill chamber hole within the water entry hole does not require full “alignment” of central axes of the respective holes.

In another example, there is shown in FIGS. 9(C) and (D) a situation in which a −12 degree offset has been applied between cartridge position and entry hole 34 of the device. Here, the −12 degree offset provides very little chamber entry hole 220 exposure in FIG. 9(C) at the start of a heating cycle (approximately 5% according to FIG. 11), but the then 6 degree of indexation as applied by the prior art indexing mechanism still does not fully align chamber hole 220 and device hole 34 at the end of the cycle as shown in FIG. 9(D).

In a final example, a device is shown in FIGS. 10(C) and 10(D) (FIGS. 10(A) and (B) show the prior art for comparison) in which there is applied a −15 degree offset at the start of the heating cycle and in which the indexing mechanism 100 of the device has been altered in gearing to provide 15 degrees advancement during warm up and 15 degrees further advancement during cool down.

Here, applying a −15 degree offset to the positioning of the refill cartridge, with respect to a fully aligned state, will lead to a 0% open area (i.e. the detergent chamber is fully covered by the closed part of the lid 3 of the device) at the start of a heating cycle as shown in FIG. 10(C), whilst the change in gearing of the device means that applying a 15 degree advance during the heating cycle brings the two holes into full exposure, followed by complete alignment.

This arrangement ensures that during any cold pre-wash cycles there is zero alignment of the two holes.

It can be seen that, whilst not required, in each case of changing offset, it may be desirable to have a corresponding gearing within the indexing mechanism—so that for a −15 degree offset, a 15 degree “heat up” indexation brings the holes into alignment (although full “exposure” is achieved already at 13 degrees of indexation see FIG. 11). This could be applied to the 12 degree offset case too for instance.

Stated in another way, in some cases, the indexing mechanism may be preferentially arranged to apply an indexation of substantially “Y” degrees during a heating cycle of the device, for a case where an offset of “−Y” degrees is present between the entry hole (220) of a selected chamber and the hole (34) of the directing means at the start of a wash cycle so as to effectively align the respective holes during the heating phase.

For a 12 chamber device having an 8 mm inlet hole 220 to each chamber and a 6 mm device lid hole 34, FIG. 11 shows a graph of offset versus percentage exposure at the beginning of a wash cycle. This clearly shows reduction in the open area as the offset increases towards −15 degrees. Put in another way, for a circular device having X equally spaced chambers, each chamber occupies 360/X degrees and as offset tends towards 360/2X then the detergent loss problem becomes increasingly less significant.

The skilled man will realise that by appropriate offset and indexing a device may be provided in which any desired timing of hole alignment versus temperature may be provided so as to account for, for instance, the fact that pre-wash cycles in the united states may have heated water as opposed to cold water.

Specifically, the device of the present invention may be supplied in a given configuration so as to have any desired amount of offset at the start of a washing cycle and that gearing of the indexation mechanism of the device may be set for different sales markets, or even for particular ware washing machines to tune/optimise the performance of the device and thereby effectively maximize cleaning potential by adjusting dissolution of the detergent. In this way “loss” of detergent during any pre-wash phase may be balanced against any given speed of dissolution of detergent during a main wash phase.

Various modifications to the device are of course possible, without departing from the scope of the appended claims.

1. A multi-dosing detergent delivery device, the device comprising a housing for receiving therein, in use, a cartridge having a plurality X of chambers each accommodating a detergent composition, a directing means to direct, in use, wash liquor selectively into a selected chamber of the cartridge to contact the detergent composition therein, an outlet to allow the detergent loaded wash liquor to exit the device and indexing means for automatic movement of said cartridge in use relative to said directing means, the device further comprising means for blocking or obstructing passage of water/wash liquor from said directing means to the selected chamber during part of a wash cycle.

2. A device according to claim 1, wherein said means for blocking or obstructing passage of water/wash liquor comprises providing an offset between an entry hole of a selected chamber of the cartridge and a hole the directing means, so that the hole of the directing means and the chamber entry hole (220) are not in full alignment prior to commencement of wash cycles.

3. A device according to claim 2, wherein the offset is arranged so as to provide an exposure percentage “M” of the chamber entry hole prior to commencement of wash cycles, where “M” is less than 100%.

4. A device according to claim 3, wherein “M” is within the range of 0 to 80%.

5. A device according to claim 2, wherein gearing of said indexing means is arranged to apply an indexation so as to proceed to a 100% exposure of the chamber entry hole during said heating cycle.

6. A device according to claim 2, wherein said device is cylindrical and said X chambers each occupy (360/X) degrees of said cylinder and the offset between the hole of the directing means and the chamber entry hole is “−Y” degrees prior to commencement of wash cycles.

7. A device according to claim 6, wherein “Y” is between 4 and 15.

8. A device according to claim 2, wherein said chamber entry hole is larger than the hole of said directing means, such that indexation of said device during a heating cycle will bring about a 100% exposure level before alignment of centre points of said respective holes along a common central axis occurs

9. A device according to claim 8, wherein said chamber entry hole is substantially 8 mm in diameter and said hole of said directing means is substantially 6 mm in diameter.

10. (canceled)

11. A device according to claim 3 wherein gearing of said indexing means is arranged to apply an indexation so as to proceed to a 100% exposure of the chamber entry hole during said heating cycle.

12. A device according to claim 4 wherein gearing of said indexing means is arranged to apply an indexation so as to proceed to a 100% exposure of the chamber entry hole during said heating cycle.

13. A device according to claim 3, wherein said device is cylindrical and said X chambers each occupy (360/X) degrees of said cylinder and the offset between the hole of the directing means and the chamber entry hole is “−Y” degrees prior to commencement of wash cycles.

14. A device according to claim 13, wherein “Y” is between 4 and 15.

15. A device according to claim 4, wherein said device is cylindrical and said X chambers each occupy (360/X) degrees of said cylinder and the offset between the hole of the directing means and the chamber entry hole is “−Y” degrees prior to commencement of wash cycles.

16. A device according to claim 15, wherein “Y” is between 4 and 15.
